(19) United States
(12) Patent Application Publication
(10) Pub. No.: US 2019/0316461 A1
(43) Pub. Date: Oct. 17, 2019

(54) A DEPTH MEASUREMENT APPARATUS

(71) Applicant: REFLEX INSTRUMENTS ASIA PACIFIC PTY LTD, Balcatta (AU)

(72) Inventor: Gary Cavanough, Chapel Hill (AU)

(21) Appl. No.: 16/466,534

(22) PCT Filed: Dec. 5, 2017
(86) PCT No.: PCT/AU2017/051333

§ 371 Date: Jun. 4, 2019

(30) Foreign Application Priority Data
Dec. 5, 2016 (AU) 2016904994

(51) Int. Cl. E21B 47/04; G01B 11/02; G01B 5/02; G01B 5/18; G01F 23/00

(52) U.S. Cl. CPC E21B 47/042; G01B 11/02; G01F 23/0023; G01B 5/18; G01B 5/02

(57) ABSTRACT

A depth measurement apparatus for measuring the depth of a hole and/or the depth of any liquid or slurry in the hole. The depth measurement apparatus comprises a spool containing a length of cord having a bob attached to a free end of the cord remote from the spool. The bob is a solid body, preferably being in the shape of a sphere, a spheroid or an ellipsoid. The apparatus has a measuring device arranged to measure a length of the cord dispensed from the spool during use, which indicates the depth of the hole. The measuring device is also arranged to measure the acceleration rate at which the cord is dispensed from the spool, wherein a change in the acceleration rate indicates that the bob has entered a liquid or slurry.

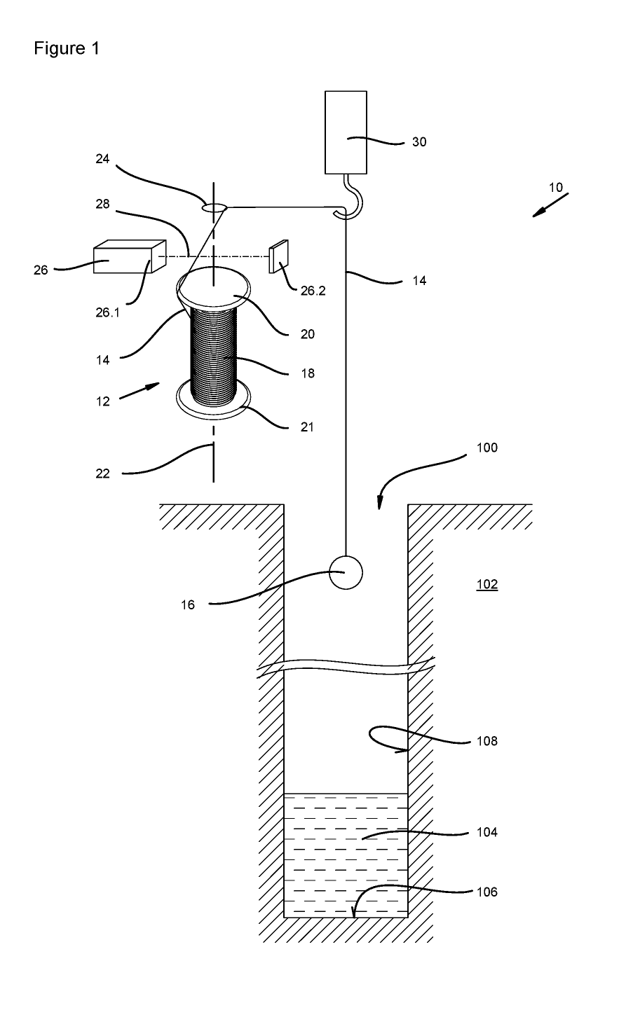

### FIELD OF INVENTION

The present invention relates to a depth measurement apparatus.

More particularly, the present invention relates to a depth measurement apparatus for use in the mining and construction industry to measure a depth of a hole, e.g. a blast hole or bore hole formed during mining operations.

### BACKGROUND ART

Once a blast hole or bore hole is formed, it is necessary to measure the depth thereof and to determine if any liquid or drilling slurry is present in the bore hole before further mining procedures can be undertaken. In the prior art, the depth measurement is performed by feeding a measuring line into the bore hole. For example, it is known to lower a tape measure with a weight attached to the end of the tape down the bore hole so that both the total hole depth and liquid/slurry depth are recorded. This process in known as “dipping” and normally a task requiring two or more people wherein one person will operate the tape measure while another person records the measurements. The depth measurement is used to determine if the bore hole has collapsed and the type of explosives subsequently to be used in a particular bore hole.

The use of alternative depth measuring means, which do not use a weighted string apparatus, often encounter difficulties due to the bore hole's relatively narrow diameter, its commonly encountered non-vertical orientation, the rough and irregular surfaces of the bore hole side wall and/or muddiness of liquid or slurry in the bore hole. For example, the relatively small diameter of the bore hole limits the ability for ultrasound to propagate down the length of the bore hole; non-vertical and non-linear bore holes cause instruments that are lowered down the bore hole to get stuck on its side wall; muddy water prevents transmission and penetration of a laser beam light; and mud clogs up instruments that are lowered down and recovered from the bore hole.

Furthermore, the need for multiple operators in dipping a bore hole with a measuring tape is costly.

The presence of liquid or slurry at the bottom of bore holes can dilute blasting agents causing misfires or low order detonation. Detection and determination of the depth of any water at the bottom of the bore hole tends to be difficult in bore holes having a depth greater than thirty meters.

It is to be understood that, if any prior art publication is referred to herein, such reference does not constitute an admission that the publication forms a part of the common general knowledge in the art, in Australia or any other country.

### SUMMARY OF THE INVENTION

According to one aspect of the present invention, there is provided a depth measurement apparatus for measuring the depth of a hole and/or the depth of any liquid or slurry in the hole, the depth measurement apparatus comprising:
a spool containing a length of cord;
a bob attached to a free end of the cord remote from the spool, wherein the bob is a solid body;
a measuring device being arranged to measure a length of the cord dispensed from the spool during use, the measuring device further being arranged to measure an acceleration rate at which the cord is dispensed from the spool during use.

The bob may be directly attached to the cord, such as by crimping or tying.

The cord may have a weight that is negligible in comparison to the weight of the bob. Additionally, the cord may have a low tensile elasticity.

The bob may have a density greater than any liquid or slurry that would be expected to be found in a bore hole.

The bob has a smooth regular outer surface. In some embodiments, the bob has the shape of a sphere, a spheroid, or an ellipsoid. In one embodiment, the bob is a fishing sinker. The bob may be encased in a plastic lining or coated with a lubricant.

The bob may be selected to have a weight of about fifteen grams or more for each fifty meter length of cord that is expected to be dispensed from the spool.

The spool may be cylindrical having a central axis with the spool being non-rotatable about its central axis.

The depth measurement apparatus may include a guide eyelet aligned along the central axis, wherein the cord is arranged to pass through the eyelet, in use to cause the cord to be circumferentially dispensed from the spool towards the central axis.

The measuring device may comprise a friction element being arranged, in use, to impart a small breaking force to the cord, wherein the breaking force is sufficient to prevent the cord dispensing under its own weight.

The measuring device may comprise an optical interrupter arranged to emit a beam of light transversely across the central axis such that dispensing of the cord in use will periodically interrupt the beam.

The depth measurement apparatus may include a weight scale being arranged to measure a weight of the bob.

The depth measurement apparatus may include multiple bobs attached to the free end of the cord wherein each of the multiple bobs is directly attached to the cord in a linear array.

According to a further aspect of the present invention, there is provided a method of measuring the depth of a hole and/or the depth of any liquid or slurry in the hole, the method comprising the steps of:
attaching a bob to a cord;
dropping the bob into the hole so that the bob can descend along the full length of the hole and come to rest at a base of the hole;
measuring the length of the cord dispensed into the hole to determine a total depth of the hole;
attaching the cord to a weight scale; and
pulling the bob up from the hole while measuring the weight of the bob and determining a depth at which the weight of the bob increases, thereby indicating the loss of any buoyancy imparted by a liquid or slurry present in the hole.

The loss of buoyancy may be indicated by an increase of about 30% in the weight of the bob

### BRIEF DESCRIPTION OF DRAWING

The present invention will now be described, by way of example, with reference to the accompanying schematic drawing, in which:
there is shown an illustration of a depth measurement apparatus located in use for measuring the depth of a bore hole.

### DETAILED DESCRIPTION OF THE DRAWING

Referring to the drawing, there is shown a depth measurement apparatus 10 according to an embodiment of the invention for use in measuring and recording a depth of a bore hole 100. The bore hole 100 is normally formed in ground 102 by drilling. In some instances the bore hole 100 remains dry, but in other instances the bore hole can contain some liquid (e.g. water) or drilling slurry 104 at the bottom of the bore hole 100. The bore hole 100 has a base 106 and an annular side wall 108.

The apparatus 10 includes a spool 12 holding a length of cord 14 for being dispensed therefrom with a bob 16 being attached to a free end of the cord 14 remote form the spool 12. It is envisaged that the cord 14 will have a length of several kilometres and be made of a lightweight material. In one example, the cord 14 can be a lightweight fishing line made of synthetic fibres, such as nylon or polyethylene. In another example, the cord 14 can be a cotton thread. Preferably the cord 14 will have a low tensile elasticity so that when dispensed the cord 14 will not unduly stretch under the weight of the bob 16 or the weight of any cord 14 that has already been dispensed.

The bob 16 is a solid body having a density higher than the density of any liquid 104, mud or drilling slurry that will be present at the bottom of a bore hole 100. The density of the bob 16 should preferably be greater than 4000 kg/m³. In the current embodiment, the bob 16 is made of metal, for example, such as iron, steel, lead, brass, tungsten or bismuth. The bob 16 has a relatively smooth and regular outer surface without any protrusions that could cause the bob 16 to become lodged or jammed against the side wall 108 of the bore hole 100. Accordingly, it is envisaged that the bob 16 will have the shape of a sphere, a spheroid, or an ellipsoid, i.e. be roughly ball shaped or egg-shaped. In the exemplary embodiment, the bob 16 is a commonly available lead ball fishing sinker as would normally be used with a fishing line. It is envisaged that in some embodiments the bob 16 can be encased in a plastic lining or be coated with a lubricant (e.g. grease).

The bob 16 can be tied to the cord 14 or can be attached thereto by crimping. It is envisaged that the bob 16 will be attached directly to the cord 14.

The bob 16 is selected to have a weight being sufficient to, in use, exceed the weight of any length of cord 14 to be dispensed from the spool 12 so that any dispensed cord 14 will have a weight that is negligible in comparison to the weight of the bob 16. Generally, the weight of the bob 16 will be selected to be about fifteen grams for each fifty meter length of cord 14 that is expected to be dispensed from the spool 12. For example, when a hundred-meter length of cord 14 is expected to be to be dispensed from the spool 12 then a bob 16 having a weight of about thirty grams will be used. Similarly, when a two hundred-meter length of cord 14 is expected to be to be dispensed from the spool 12 then a bob 16 having a weight of about sixty grams will be used. In order to constitute such a sixty gram bob 16, a single bob of 60 grams can be provided or (as described below) multiple bobs of lesser weight can be cumulated and each joined to the cord 14, e.g. four fifteen gram bobs. Clearly, it will also be possible to use bobs 16 being heavier than fifteen grams for the equivalent length of cord 14. Accordingly, it would be possible to use a sixty gram bob with a fifty-meter length of cord. However it is currently considered that doing so will not provide any substantial benefit; although it may slightly shorten the length of time needed for the bob to fall to the base of the hole, it would have the disadvantage of requiring an operator to carry a much heavier supply of bobs for use in measuring further bore holes.

In the exemplary embodiment, the spool 12 is generally cylindrical having a body 18 with opposed disc-shaped rims 20, 21 at each end thereof. The spool 12 has a central axis 22 and is supported in a stationary manner so that the spool 12 does not rotate around the axis 22 during use. A guide eyelet 24 is supported relative to the spool 12 with the cord 14 being passed through the eyelet 24. The eyelet 24 is substantially aligned along the axis 22 so that in use, as the cord 14 is dispensed from one end of the spool 12, the cord 14 will contact and slide circumferentially around rim 20. In this regard, it will be appreciated that the rim 20 is smooth so that the cord 14 can slide unhindered around the rim 20 without much friction. If needed, more than one guide eyelet can be provided so that the cord 14 can be properly directed from the spool 12 to the bore hole 100.

One problem that may be encountered in use is that once the bob 16 has come to rest on the base 106, the cord 14 may continue unwinding under the weight of the cord section already dispensed into the bore hole 100. Accordingly, in some embodiments a friction element (not shown in the drawing) can be provided over which the cord 14 will pass to impart a small breaking force to the cord 14, wherein in use the breaking force is sufficient to prevent the cord 14 dispensing under its own weight. For clarity, it should be appreciated that the breaking force applied by the friction element should only overcome the gravitation force impacting on the cord 16, but not that impacting on the bob 16. In one embodiment, the friction element is a cloth material lining (such as felt) that is attached around the rim 20. In another embodiment, the cloth material lining can be attached to the guide eyelet 24. In yet other embodiments, the friction element can be knurling or roughening of the rim 20 or eyelet 24.

The apparatus 10 includes a measuring device 26 for determining a length of the cord 14 that is dispensed from the spool 12. The measuring device 26 comprises a processor and an optical sensor, such as an optical interrupter or phototransistor. As is commonly known in the art, an optical interrupter is a sensor having a laser emitter provided on a first leg 26.1 and a shielded infrared detector on an opposed second leg 26.2. By emitting a beam 28 of light from the first leg 26.1 to the second leg 26.2, the sensor can detect when an object passes between the legs and thus breaking the beam 28. In order for the beam 28 to be broken, the cord 14 should have cross-sectional diameter that is larger than the cross-sectional diameter of the beam 28. However, if the diameter of the cord 14 is smaller than the diameter of the beam 28, then a collimator can be provided to further narrow the diameter of the beam 28 until it is smaller than that of the cord 14. In the exemplary embodiment, measuring device 26 is positioned so that the beam 28 extends transversely across the axis 22 at a location between the rim 20 and the eyelet 24. Accordingly, in use, the movement of the cord 14 around the rim 20 will periodically break the beam 28 after each half revolution around the rim 20. In this way, the measuring device 26 can determine both the length of the cord 14 that is dispensed from the spool 12 and also the acceleration rate at which the cord 14 is dispensed. It is appreciated that as the amount of cord 14 remaining on the spool 12 decreases, so too will the outer circumference of the cord decrease and accordingly the length of cord being dispensed for each revolution of the cord 14 around the rim 20. However, this can be accounted for using mathematical techniques known in the art and by having the measuring device 26 continually track the length of cord 14 remaining on the spool 12 and adjusting the measured values to compensate for the change in circumference.

The apparatus 10 optionally further includes a weight scale 30 being arranged to measure the weight of the bob 16 and cord 14 dispensed from the spool 12. In the exemplary embodiment, the weight scale 30 is a spring scale being a hand-held accessory but it can also be formed as part of the apparatus 10. It will be understood that the weight of the bob 16 will differ depending on the fluid medium in which the bob 16 is located. Thus when the bob 16 is located in air the weight of the bob 16 will be substantially the same as its original above-ground weight. However, if the bob 16 is in a denser fluid, such as water or drilling mud, then the denser fluid will impart a certain buoyancy to the bob 16 causing the weight scale to measure a lighter weight for the bob 16. Generally, the bob 16 will be about 30% lighter when located in water when compared to the weight of the bob 16 when located in air.

In use, when the depth of a bore hole 100 is to be measured, the bob 16 is dropped into the bore hole 100 so that it can fall freely. Because the weight of the bob 16 greatly exceeds the weight of the cord 14, the bob 16 is able to fall as if untethered. The shape of the bob 16 as well as any plastic lining or lubricant on the bob 16 assist in preventing the bob 16 from becoming lodged against the side wall 108 of the bore hole 100. The measuring device 26 monitors the length of and also the acceleration rate at which the cord 14 is unwound from the spool 12. The acceleration rate will remain relatively constant for the period while the bob 16 falls through air. However, when the bob 16 encounters the liquid 104, the acceleration rate will greatly decrease due to the increased friction as it enters and starts descending through the liquid 104. The measuring device is thus able to determine the instant at which the bob 16 entered the liquid 104 and calculate the distance that the bob 16 has travelled from its release point above the ground 102 to the surface of the liquid 104. Further, the measuring device 26 continues to record the length of and the acceleration rate at which the cord 14 is unwound form the spool 12 from the instant that the bob 16 enters the liquid 104 until the time that the bob 16 comes to rest on the base 106 (obviously at that time the cord 14 will no longer continue unwinding from the spool 12). It will be appreciated that both the forces that act on the cord 14 as it unwinds from the spool 12 and the mass of the cord 14 are negligible in comparison to the weight of the bob 16 and hence, when the bob 16 lands on the base 106, the cord 14 will immediately stop unwinding or dispensing—this can be ensured by the provision of the abovementioned friction element provided on the rim 20 or the eyelet 24. Accordingly, the measuring device 26 is also able to calculate the distance that the bob 16 has travelled from the surface of the liquid 104 to its rest point on the base 106.

It will be appreciated that when the bob 16 is initially released above the ground 102, it will be able to freely fall down the bore hole 100. Thus any collisions with the side wall 108 will only result in low magnitude changes in acceleration that will not have a great influence on the acceleration rate of the bob 16 and thus will not result in an incorrect liquid entry being concluded by the measuring device 26.

On the occasion that the amount of liquid 104 at the bottom of the bore hole 100 is rather small, e.g. being less than 500 mm deep, it may occur that the time difference between the bob 16 entering the liquid 104 and subsequently landing on the base 106 is too small to accurately determine the depth of the liquid 104. In such case a further calculation can be made as follows. Once the bob 16 comes to rest on the base 106, the cord 14 is attached to the weight scale 30 and the cord 14 then retracted from the bore hole 100. The weight scale 30 will measure the weight of the bob 16 as it is drawn upwards within the bore hole 100 and, at the time that the bob 16 exits the liquid 104 and loses the buoyancy force applied thereby, note that the weight of the bob 16 increases by the about 30% and be able to determine the distance that the bob 16 has travelled up within the bore hole 100. In such cases, as the depth of the liquid 104 will be relatively shallow, a simple manual measurement of the amount of cord withdrawn from the bore hole 100 can be made. In one embodiment, the manual measurement can be manually entered into the measuring device 26 and recorded. Alternatively, if the exact depth of water need not be recorded, then the operator can merely record an indication that there is some liquid 104 at the bottom of the bore hole 100.

If there is no change in the weight of the bob 16 after it has been withdrawn by about one meter, then it can be assumed that there is no liquid 104 in the bore hole 100 and that it is dry along its full length to the base 106.

On completion of each depth measurement, the cord 104 is cut and dropped into the bore hole 100. Thereafter a new bob 16 is attached to the cord 14 for conducting a subsequent measurement in other bore holes.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

For example, it may be that multiple bobs 16 are utilised. In such case each of the bobs 16 are attached directly to the cord 14, e.g. by crimping or tying. Where multiple bobs 16 are provided the bobs will be attached one above the other to the cord 14 in a linear array. In such case the bobs can be located in abutting contact with each other or be spaced slightly apart from each other. A further feature that may be considered an advantage in such an embodiment is that, when the depth of the liquid 104 is determined by lifting the bobs 16 from the base, discrete measurements of the liquid surface can be made by determining the change in weight of the bobs as each one of the multiple bobs consecutively exits the liquid 104, thereby providing a double or repeated checking of the depth measurement.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. A depth measurement apparatus for measuring the depth of a hole and/or the depth of any liquid or slurry in the hole, the depth measurement apparatus comprising:
a spool containing a length of cord;
a bob attached to a free end of the cord remote from the spool, wherein the bob is a solid body;
a measuring device being arranged to measure a length of the cord dispensed from the spool during use, the measuring device further being arranged to measure an acceleration rate at which the cord is dispensed from the spool during use.

2. A depth measurement apparatus as claimed in claim 1 wherein the bob is directly attached to the cord.

3. A depth measurement apparatus as claimed in claim 2, wherein the bob is attached to the cord by crimping or tying.

4. A depth measurement apparatus as claimed in claim 1, wherein the cord has a weight that is negligible in comparison to the weight of the bob.

5. A depth measurement apparatus as claimed in claim 1, wherein the cord has a low tensile elasticity.

6. A depth measurement apparatus as claimed in claim 1, wherein the bob has a density greater than any liquid or slurry that would be expected to be found in a bore hole.

7. A depth measurement apparatus as claimed in claim 1, wherein the bob has a smooth regular outer surface.

8. A depth measurement apparatus as claimed in claim 7, wherein the bob has the shape of a sphere, a spheroid, or an ellipsoid.

9. A depth measurement apparatus as claimed in claim 1, wherein the bob is a fishing sinker.

10. A depth measurement apparatus as claimed in claim 1, wherein the bob is encased in a plastic lining or coated with a lubricant.

11. A depth measurement apparatus as claimed claim 1, wherein the bob is selected to have a weight of about fifteen grams or more for each fifty meter length of cord that is expected to be dispensed from the spool.

12. A depth measurement apparatus as claimed in claim 1, wherein the spool is cylindrical having a central axis and the spool is non-rotatable about its central axis.

13. A depth measurement apparatus as claimed in claim 12, further including a guide eyelet aligned along the central axis, wherein the cord is arranged to pass through the eyelet, in use to cause the cord to be circumferentially dispensed from the spool towards the central axis.

14. A depth measurement apparatus as claimed in claim 13, wherein the measuring device comprises a friction element being arranged, in use, to impart a small breaking force to the cord, wherein the breaking force is sufficient to prevent the cord dispensing under its own weight.

15. A depth measurement apparatus as claimed in claim 13, wherein the measuring device comprises an optical interrupter arranged to emit a beam of light transversely across the central axis such that dispensing of the cord in use will periodically interrupt the beam.

16. A depth measurement apparatus as claimed in claim 1, further including a weight scale being arranged to measure a weight of the bob.

17. A depth measurement apparatus as claimed in claim 1, wherein the bob comprises multiple bobs attached to the free end of the cord and wherein each of the multiple bobs is directly attached to the cord in a linear array.

18. A method of measuring the depth of a hole and/or the depth of any liquid or slurry in the hole, the method comprising the steps of:
attaching a bob to a cord;
dropping the bob into the hole so that the bob can descend along the full length of the hole and come to rest at a base of the hole;
measuring the length of the cord dispensed into the hole to determine a total depth of the hole;
attaching the cord to a weight scale; and
pulling the bob up from the hole while measuring the weight of the bob and determining a depth at which the weight of the bob increases, thereby indicating the loss of any buoyancy imparted by a liquid or slurry present in the hole.

19. A method as claimed in claim 18, wherein the loss of buoyancy is indicated by an increase of about 30% in the weight of the bob.
